(19) United States
(12) Patent Application Publication
(10) Pub. No.: US 2025/0019596 A1
(43) Pub. Date: Jan. 16, 2025

(54) METHOD FOR PRODUCING WASTE PLASTIC PYROLYSIS OIL WITH REDUCED CHLORINE

(71) Applicants: SK INNOVATION CO., LTD., Seoul (KR); SK GEO CENTRIC CO., LTD., Seoul (KR)

(72) Inventors: Sanghwan JO, Daejeon (KR); Sookil KANG, Daejeon (KR); Howon LEE, Daejeon (KR); Jaeheum JUNG, Daejeon (KR)

(21) Appl. No.: 18/705,593

(22) PCT Filed: Dec. 28, 2022
(86) PCT No.: PCT/KR2022/021545

§ 371 Date: Apr. 29, 2024

(30) Foreign Application Priority Data
Dec. 29, 2021 (KR) 10-2021-0190857

(51) Int. Cl. C10G 1/10

(52) U.S. Cl. CPC C10G 1/10; C10G 2300/1003; C10G 2300/202; C10G 2300/4006

(57) ABSTRACT

The present disclosure provides a method for producing waste plastic pyrolysis oil with reduced chlorine, the method including: a first step of preparing a feed containing 1 to 25 parts by weight of moisture based on 100 parts by weight of waste plastic; and a second step of performing pyrolysis of the feed at 400 to 600° C.

### TECHNICAL FIELD

The present disclosure relates to a method for producing waste plastic pyrolysis oil with reduced chlorine.

### BACKGROUND ART

Since pyrolysis oil obtained by pyrolyzing waste plastics has a higher content of impurities such as chlorine, nitrogen, metals, etc. compared to oil produced from crude oil by a general method, it may not be used directly as a high value-added fuel such as gasoline, diesel oil, etc., and needs to undergo a refinery process.

Although in a conventional refinery process, chlorine is converted into HCl and removed by hydrogenation under a hydrogenation catalyst, waste plastic pyrolysis oil contains a high amount of chlorine, resulting in excessive HCl during hydrogenation, which causes problems such as corrosion of equipment, abnormal reaction, deterioration of product properties, etc. To remove chlorine oil by utilizing the existing refinery process, a Cl reduction pretreatment technology is required to reduce a chlorine content in waste plastic pyrolysis oil to a level that may be introduced into the refinery process.

In addition, since moisture contained in conventional waste plastic causes problems such as lowering an efficiency of removing impurities in the refinery process and lowering a purity of the produced pyrolysis oil, water-containing waste plastic is disposed of in a feed selection process, or is introduced into a heating furnace to perform a pyrolysis process after removing water through a pretreatment process such as a drying process or a dehydration process. However, additional costs are required in a process of providing drying facilities or pretreatment facilities such as a heater or a blowing fan, and a purge process using an inert gas such as nitrogen is necessarily accompanied, resulting in poor process efficiency.

Therefore, there is a need for a technology capable of economically producing waste plastic pyrolysis oil with reduced chlorine while using moisture-containing or wet waste plastic feed as it is without a pretreatment process such as drying.

### RELATED ART DOCUMENT

### [Patent Document]

(Patent Document 1) Korean Patent No. 10-1026199

### DISCLOSURE

### Technical Problem

An object of the present disclosure is to provide a method for producing waste plastic pyrolysis oil in which pyrolysis oil may be obtained in high yield and a chlorine content in the pyrolysis oil is minimized by using a waste plastic feed containing moisture in a specific range as it is without a pretreatment process such as drying.

Another object of the present disclosure is to provide a method for producing waste plastic pyrolysis oil capable of reducing equipment costs and utility use, and improving economic efficiency and process efficiency by omitting a pretreatment/drying process for waste plastic and by not performing a purge process for creating an inert atmosphere in a pyrolysis process.

### Technical Solution

In one general aspect, a method for producing waste plastic pyrolysis oil with reduced chlorine includes: a first step of preparing a feed containing 1 to 25 parts by weight of moisture based on 100 parts by weight of waste plastic; and a second step of performing pyrolysis of the feed at 400 to 600° C.

The moisture may include moisture contained in the waste plastic.

The second step may be performed in a non-oxidizing atmosphere.

The non-oxidizing atmosphere may be a water vapor atmosphere formed by pressurizing and purging a reactor with vaporized water vapor.

The second step may be performed under a normal pressure condition.

The second step may be performed in a batch reactor.

A total chlorine content in the waste plastic pyrolysis oil produced through the first and second steps may be 300 ppm or less.

A total chlorine content in the pyrolysis oil produced through the first and second steps may be removed by 80% or more compared to the feed.

### Advantageous Effects

According to the present disclosure, the pyrolysis oil may be obtained in high yield and the chlorine content in the pyrolysis oil may be minimized by using the waste plastic feed containing moisture within a specific range as it is without a pretreatment/drying process.

According to the present disclosure, it is possible to reduce equipment costs and utility use and to improve economic efficiency and process efficiency by omitting a pretreatment/drying process for waste plastic and by not performing a purge process for creating an inert atmosphere in a pyrolysis process.

### BEST MODE

As used herein, the singular form of terms may be interpreted as including the plural form unless otherwise indicated.

Numerical ranges as used herein include a lower limit, an upper limit, and all values within that range, all double-defined values, and all possible combinations of upper and lower limits of numerical ranges defined in different forms.

Unless otherwise defined herein, values outside the numerical range that may arise due to experimental errors or rounded values are also included in the defined numerical range.

As referred to herein, the term “comprise” is an “open” description having the meaning equivalent to expressions such as “include,” “contain,” “have,” “feature”, and does not exclude elements, materials, or process that are not further listed.

The unit of % used herein refers to % by weight unless otherwise specified.

The unit of ppm used herein refers to ppm by mass unless otherwise specified.

The boiling point (bp) used herein without particular mention refers to a boiling point at 1 atm (normal pressure).

MpaG is used herein without particular mention is a gauge pressure and refers to a pressure measured based on 1 atm (normal pressure).

Conventionally, moisture-containing waste plastic is disposed of in a sorting process, or subjected to a pretreatment process such as a drying process or a dehydration process to remove moisture in the waste plastics, and then introduced into a heating furnace to perform a pyrolysis process.

However, in order to perform the pretreatment process, additional facilities such as a heater, a hot air dryer, or a blowing fan are required, so significant costs are incurred, and a purge process using an inert gas such as nitrogen is essential, which is disadvantageous in terms of process efficiency.

In addition, although in the conventional refinery process of waste plastic pyrolysis oil, chlorine was converted into HCl and removed by hydrogenation under a hydrogenation catalyst, waste plastic pyrolysis oil contains a high amount of chlorine, resulting in excessive HCl during hydrogenation, which causes problems such as corrosion of equipment, abnormal reaction, deterioration of product properties, etc.

Therefore, there is a need for a technology capable of producing waste plastic pyrolysis oil with reduced chlorine by introducing moisture-containing or wet waste plastic into a heating furnace as it is without a pretreatment process such as drying, and performing a pyrolysis process.

Accordingly, the present disclosure provides a method for producing waste plastic pyrolysis oil with reduced chlorine, the method including a first step of preparing a feed containing 1 to 25 parts by weight of moisture based on 100 parts by weight of waste plastic; and a second step of performing pyrolysis of the feed at 400 to 600° C.

The waste plastic may be household plastic waste (household waste plastic) or industrial plastic waste (industrial waste plastic).

The household waste plastic is a plastic mixed with PVC, PS, PET, PBT, etc. other than PE and PP, and specifically, may be mixed waste plastic containing 3% by weight or more of PVC together with PE and PP. The chlorine content may be 5,000 ppm or more, and specifically 5,000 to 15,000 ppm based on 100 parts by weight of the waste plastic. The household waste plastic may contain moisture in various ranges, and typically contain a high content. The household waste plastic may contain, for example, 0.01 to 40% by weight of water, but this is an example and the preset disclosure is not necessarily limited thereto.

The industrial waste plastic is industrial wastes such as scraps or defective products generated during producing processes in industries, and PE/PP accounts for most of them. The chlorine content may be 100 to 1,000 ppm, specifically 500 to 1,000 ppm, and more specifically, 700 to 1,000 ppm based on 100 parts by weight of the waste plastic. The industrial waste plastic maintains a relatively clean state due to scraps generated in the production process, and thus has a low chlorine content compared to the household waste plastic and a low moisture content of less than 0.03% by weight. However, it is characterized by a high content of organic chlorine caused by an adhesive or dye component, and particularly a high ratio of chlorine contained in an aromatic ring.

The first step is to prepare a feed containing 1 to 25 parts by weight of moisture based on 100 parts by weight of waste plastic, which may be prepared by adjusting moisture to an appropriate range in various ways according to the composition of the waste plastic.

In an exemplary embodiment of the present disclosure, the moisture may be moisture contained in the waste plastic. For example, a feed may be prepared by selecting the household waste plastic satisfying parts by weight of moisture, like the household waste plastic. Since the household waste plastic with a high moisture content are used as it is, a drying process or a dehydration process may be omitted, thereby improving process efficiency or economic efficiency.

In addition to the advantages mentioned above, the moisture may be prepared by mixing the waste plastic with water. For example, if the moisture content in the waste plastic is extremely low, such as 0.03% by weight or less, a feed containing 1 to 25 parts by weight of water based on 100 parts by weight of the waste plastic may be prepared by mixing a certain amount of moisture with the waste plastic. Mixing may be performed in a conventionally known manner, and for example, mixing may be performed by introducing waste plastic feed into a batch reactor and adding a certain amount of water, but this is just an example and the present disclosure is not necessarily limited thereto.

In this way, it is possible to prepare a feed whose moisture is adjusted to an appropriate range by adopting an appropriate method according to the composition of the waste plastic.

The second step is a step of performing pyrolysis of the feed at 400 to 600° C., and the feed containing the waste plastic is converted into a hydrocarbon product. The hydrocarbon product includes a gas phase, and pyrolysis gas, which is the gas phase, is introduced into a condenser and then cooled, and is recovered in a storage tank as liquid pyrolysis oil.

When a feed containing 1 to 25 parts by weight of moisture based on 100 parts by weight of the waste plastic is pyrolyzed at 400 to 600° C., the chlorine content in the generated pyrolysis oil may be minimized. Contrary to conventional knowledge that the content of impurities such as chlorine in the generated pyrolysis oil increases as the moisture content in the waste plastic increases, the chlorine content in the generated pyrolysis oil when moisture is contained in a range of 1 to 25 parts by weight based on 100 parts by weight of the waste plastic may be minimized. Since chlorine dissociated from the waste plastic is trapped in moisture in a high-temperature pyrolysis process of the waste plastic, it is possible to prevent the regeneration of organic chlorine by recombination of dissociated chlorine with olefin in a pyrolysis product. When the moisture weight and pyrolysis temperature ranges are satisfied, a chlorine removal efficiency is maximized and the chlorine content in the generated pyrolysis oil may be minimized, and pyrolysis oil having a high olefin yield and a low chlorine content may be produced without adding additives/neutralizers or performing a separate pre/post treatment process in a reaction process. If the moisture content exceeds 25 parts by weight, a contact area between olefin and water in the pyrolysis product increases, and the chlorine content in the pyrolysis oil increases due to a back-mixing effect in which chlorine recombines with the olefin. In addition, excessive moisture may cause problems such as causing condensation or corrosion of pipes and deteriorating the purity or quality of the generated pyrolysis oil. If the pyrolysis temperature is less than 400° C., pyrolysis is not smoothly performed due to the moisture in the feed, and thus chlorine removal efficiency is degraded. Preferably, in a temperature range of 400° C. or more and 600° C. or less, fusion of waste plastics may be prevented, and a yield of pyrolysis oil with minimized chlorine may be maximized. The moisture may be included in preferably 2 to 25 parts by weight, more preferably 3 to 25 parts by weight, and most preferably 5 to 25 parts by weight, based on 100 parts by weight of the waste plastic.

The pyrolysis temperature may be specifically 450 to 580° C., and more specifically, 480 to 550° C.

In an exemplary embodiment of the present disclosure, the second step may be performed in a batch reactor. Specifically, the second step may be performed in any reactor capable of stirring and controlling temperature rise, and for example, pyrolysis may be performed in a rotary kiln-type batch reactor, but the present disclosure is not limited thereto.

In an exemplary embodiment of the present disclosure, the second step may be performed in a non-oxidizing atmosphere. The non-oxidizing atmosphere is an atmosphere in which waste plastic is not oxidized (combusted), and efficient pyrolysis may proceed in the atmosphere. The non-oxidizing atmosphere is, for example, an atmosphere in which the oxygen concentration is adjusted to 1% by volume or less, and may be an atmosphere of an inert gas such as nitrogen, water vapor, carbon dioxide, and argon. The pyrolysis process may be stably performed in a low-oxygen atmosphere in which the oxygen concentration is 1% by volume or less. The second step may be performed for 150 to 350 minutes in a non-oxidizing atmosphere, and when the holding time is satisfied, activation of the non-oxidizing atmosphere composition and sufficient pyrolysis may be performed, and energy consumption and operation time may be minimized, which is preferable. The second step may be specifically performed for 170 minutes to 330 minutes, and more specifically for 200 minutes to 300 minutes.

In an exemplary embodiment of the present disclosure, the non-oxidizing atmosphere may be a water vapor atmosphere formed by pressurizing and purging a reactor with vaporized water vapor. The pyrolysis process of the second step may be performed after uniformly melting a moisture-containing feed at 100 to 130° C. for 1 hour to 2 hours in order to improve reaction efficiency. In this process, water vapor is generated, and oxygen may be removed by being pressurized and purged by the water vapor. That is, since a non-oxidizing atmosphere by water vapor may be created from moisture contained in the feed, there is an advantage in that a separate purge process using an inert gas does not need to be performed.

In an exemplary embodiment of the present disclosure, the second step may be performed under a normal pressure condition. The pyrolysis reactor of the second step may be operated under the normal pressure condition to obtain pyrolysate in high yield, and the reaction may be performed in an environment with excellent work convenience and safety.

The pyrolysis gas generated through the pyrolysis may contain 5 to 35% by weight of Naphtha (bp ˜150° C.), 10 to 60% by weight of Kero (bp 150 to 265° C.), 20 to 40% by weight of LGO (bp 265 to 380° C.), and 5 to 40% by weight of UCO-2/AR (bp 380° C.˜) based on the total weight, and specifically 5 to 30% by weight of Naphtha (bp ˜150° C.), 15 to 50% by weight of Kero (bp 150 to 265° C.), 20 to 35% by weight of LGO (bp 265 to 380° C.), and 10 to 40% by weight of UCO-2/AR (bp 380° C.˜). In addition to those mentioned above, the pyrolysis gas may contain residual amounts of low-boiling hydrocarbon compounds such as methane (CH₄), ethane (C₂H₆), and propane (C₃H₈). In addition, the pyrolysis gas may have a weight ratio of light oil (total of Naphtha and Kero) to heavy oil (total of LGO and UCO-2/AR) of 0.1 to 3, 0.1 to 2.0, or 0.2 to 1.0.

Before the pyrolysis gas is introduced into the condenser, a low boiling point gas containing low boiling point hydrocarbon compounds such as methane (CH₄), ethane (C₂H₆), and propane (C₃H₈) in the pyrolysis gas may be separately recovered. The pyrolysis gas generally contains combustible materials such as hydrogen, carbon monoxide, and a low molecular weight hydrocarbon compound. Examples of the hydrocarbon compound may include methane, ethane, ethylene, propane, propene, butane, butene, etc. Since the pyrolysis gas contains combustible materials and may therefore be reused as a fuel for heating the reactor or rotary kiln.

The condenser may include a region through which cooling water flows, and the pyrolysis gas introduced into the condenser may be liquefied by the cooling water and converted into the pyrolysis oil. When the pyrolysis oil generated in the condenser rises to a predetermined level, it is transported and recovered to the storage tank.

Without limitation, the pyrolysis reactor of the second stage may be operated at 0.005 to 0.3 MpaG and the storage tank at 0.001 to 0.02 MpaG in order to form a fluid flow and improve reaction efficiency.

A heat exchanger may be further provided between the condenser and the storage tank. The pyrolysis gas uncondensed in the condenser may be introduced into the heat exchanger and condensed again, and the generated pyrolysis oil may be recovered to the storage tank. The reaction yield may be improved by recovering the uncondensed pyrolysis gas again.

The liquid pyrolysis oil recovered in the storage tank may include an oil layer and a moisture layer. In addition to the pyrolysis gas, water vapor generated from moisture is also liquefied and returned to the storage tank, and oil-water separation proceeds to form an oil layer and a moisture layer in the liquid pyrolysis oil.

The moisture layer includes a chlorine compound, which may cause corrosion of the storage tank, and a neutralizing agent may be injected into the moisture layer to prevent corrosion of the storage tank. The neutralizing agent may include an alkali metal compound or an alkaline earth metal compound having a pH of 7 or more when dissolved in water. Specifically, the neutralizing agent may include hydroxides, oxides, carbonates, hydrogen carbonates, basic carbonates, or fatty acid salts of alkali metals or alkaline earth metals. The alkali metal or alkaline earth metal may be a metal commonly used in the art, and for example, the alkali metal may include lithium (Li), sodium (Na), potassium (K), rubidium (Rb), cesium (Cs), or francium (Fr), and the alkaline earth metal may include beryllium (Be), magnesium (Mg), calcium (Ca), strontium (Sr), barium (Ba), or radium (Ra). The neutralizing agent may be added alone or in combination with a solvent such as alcohol to improve neutralization efficiency.

When the neutralizing agent is added to the moisture layer, the neutralizing agent may be added in an appropriate amount by measuring the pH of the moisture layer using a pH meter located at a bottom of the storage tank.

When the oil layer and the moisture layer are separated, the oil layer (waste plastic pyrolysis oil) with minimized chlorine may be recovered by recovering the oil layer immediately or after removing the moisture layer. The moisture layer may be discharged and removed, and the discharged moisture may be recycled to the first step after purification and reused as water mixed with waste plastic.

An electric field may be applied to effectively separate the oil layer and the moisture layer, and the oil layer and the moisture layer may be separated in a short time by electrostatic adhesion by applying the electric field. In addition, in order to increase an oil-water separation efficiency, the additive may be added as needed, and the additive may be a conventional demulsifier known in the art.

When the moisture layer is discharged and removed, by detecting the density using a density profiler, it is possible to effectively remove only the moisture layer by preventing the oil layer from being removed together when the moisture layer is removed.

In an exemplary embodiment, a total chlorine content in the waste plastic pyrolysis oil produced through the first and second steps may be 300 ppm or less. Through the waste plastic pyrolysis process of the present disclosure, it is possible to minimize the total chlorine content in the generated pyrolysis oil only by controlling the water weight and temperature range without introducing additives/neutralizers. Specifically, the total chlorine content may be 290 ppm or less, and more specifically, 280 ppm or less. The total chlorine content may be, without limitation, 10 or more and 280 ppm or less.

In an exemplary embodiment, the total chlorine content in the pyrolysis oil produced through the first and second steps may be removed by 80% or more compared to the feed. As described above, when the water weight and the pyrolysis temperature ranges are satisfied, the total chlorine content in the generated waste plastic pyrolysis oil may be minimized. A chlorine removal rate may be increased in proportion to the moisture weight, and may be reduced by 80% or more compared to the feed. The chlorine removal rate may be specifically reduced by 90% or more, and may be, without limitation, reduced to 90% or more and 97% or less. If the moisture content exceeds 25 parts by weight based on 100 parts by weight of the waste plastic, a chlorine dissociation efficiency is degraded and the chlorine removal rate is degraded due to the increase in the chlorine content in the pyrolysis oil.

Hereinafter, preferred examples and comparative examples of the present disclosure will be described. However, the following examples are only a preferred example, and the present disclosure is not limited to the following examples.

### Example 1

Household waste plastic pellets were prepared by extruding household mixed plastic containing 3% by weight or more of PVC together with PE and PP at 250° C. In the household waste plastic pellets, the total Cl content was 4000 ppm and the moisture content was 0.03% by weight. 200 g of household waste plastic pellets and 50 g of water (about 25 g of moisture per about 100 g of dry weight of waste plastic) were put into a batch reactor and pyrolysis was performed at 500° C. for 250 minutes. The reaction was performed in a non-oxidizing atmosphere by creating a non-oxidizing atmosphere with water vapor generated during the pyrolysis of waste plastics.

The produced pyrolysis gas was collected in a condenser, and waste plastic pyrolysis oil was obtained in a storage tank.

### Example 2

The waste plastic pyrolysis oil was obtained by performing the reaction in the same manner as in Example 1, except that 40 g of water (about 20 g of moisture per about 100 g of dry weight of waste plastic) was added to the batch reactor and pyrolysis was performed at 520° C. for 250 minutes.

### Example 3

The liquid waste plastic pyrolysis oil was obtained by performing the reaction in the same manner as in Example 1, except that 250 g of household waste plastic pellets containing 20% by weight of moisture (about 25 g of moisture per about 100 g of dry weight of waste plastic) were prepared, and the reaction was performed at 500° C. without adding water.

In the household waste plastic, the total Cl content was 4000 ppm.

### Example 4

The waste plastic pyrolysis oil was obtained by performing the reaction in the same manner as in Example 3, except that 250 g of household waste plastic pellets containing 17% by weight of moisture (about 20 g of moisture per about 100 g of dry weight of waste plastic) were prepared, and the reaction was performed at 540° C. In the household waste plastic, the total Cl content was 4000 ppm.

### Comparative Example 1

Waste plastic pyrolysis oil was obtained by performing the reaction under the same conditions as in Example 1, except that 60 g of water (about 30 g of moisture per about 100 g of dry weight of waste plastic) was used.

### Comparative Example 2

The waste plastic pyrolysis oil was obtained by performing the reaction under the same conditions as in Example 1, except that the reaction was performed at 300° C.

### Comparative Example 3

The waste plastic pyrolysis oil was obtained by performing the reaction under the same conditions as in Example 3, except that 250 g of household waste plastic pellets containing 23% by weight of water (about 30 g of water per 100 g of dry weight of waste plastic) were used. In the household waste plastic, the total Cl content was 4000 ppm.

### Comparative Example 4

In Example 1, the waste plastic pyrolysis oil was obtained by performing the reaction under the same conditions as in Example 1 without additionally adding water.

### Evaluation Example

Moisture in the waste plastic was measured using a Karl Fischer method.

The contents (ppm) of each of total chlorine, organic chlorine and inorganic chlorine in the obtained waste plastic pyrolysis oil were measured through ICP and XRF analysis.

TABLE 1

| | | | | | | Com. | Com. | Com. | Com. |
|---|---|---|---|---|---|---|---|---|---|
| | | Example | Example | Example | Example | Example | Example | Example | Example |
| | | 1 | 2 | 3 | 4 | 1 | 2 | 3 | 4 |
| Reactor | Waste | 199.94 | 199.94 | 200 | 207.5 | 199.94 | 199.94 | 192.5 | 199.94 |
| | plastic | | | | | | | | |
| | dry | | | | | | | | |
| | weight (g) | | | | | | | | |
| | Moisture | 0.06 | 0.06 | 50 | 42.5 | 0.06 | 0.06 | 57.5 | 0.06 |
| | in waste | | | | | | | | |
| | plastic (g) | | | | | | | | |
| | Amount of | 50 | 40 | — | — | 60 | 50 | — | — |
| | additional | | | | | | | | |
| | water | | | | | | | | |
| | added (g) | | | | | | | | |
| | Temperature | 500 | 520 | 500 | 540 | 500 | 300 | 500 | 500 |
| | (° C.) | | | | | | | | |

| | | | | | | | | |
|---|---|---|---|---|---|---|---|---|
| Pyrolysis oil | 75.8 | 76.3 | 75.1 | 75.4 | 75.1 | 45.3 | 75.4 | 75.2 |
| yield (%) | | | | | | | | |
| Total chlorine | 270 | 287 | 240 | 265 | 382 | 563 | 379 | 428 |
| (ppm) | | | | | | | | |
| Organic chlorine | 282 | 286 | 259 | 262 | 366 | 511 | 364 | 408 |
| (ppm) | | | | | | | | |
| Inorganic | 2 | 1 | 1 | 3 | 16 | 52 | 15 | 20 |
| chlorine (ppm) | | | | | | | | |

As in Examples 1 to 4, it can be confirmed that the total chlorine content in the waste plastic pyrolysis oil was all reduced to 300 ppm or less. In particular, it can be confirmed that Example 1 has a lower total chlorine content than Example 2 and it can be confirmed that Example 3 has a lower total chlorine content than Example 4. From this, it can be seen that when the water content is 25 parts by weight based on 100 parts by weight of the waste plastic, chlorine in the pyrolysis oil can be more effectively reduced than when the water content is 20 parts by weight based on 100 parts by weight of the waste plastic. Additionally, it can be seen that in Examples 1 and 2, the moisture was added separately, whereas in Examples 3 and 4, the moisture was contained in the waste plastic and in this case, the moisture is uniformly contained in the waste plastic, so a chlorine removal reaction efficiency due to the moisture was further improved.

On the other hand, it can be confirmed that in Comparative Examples 1 and 3, the total chlorine content in the pyrolysis oil was significantly increased to 382 ppm and 379 ppm, respectively. From this, it can be seen that when water was included in an amount exceeding 25 parts by weight, the total chlorine content in the pyrolysis oil rather increased. Also, it can be confirmed that in Comparative Example 4, when pyrolysis was performed in the absence of moisture, the total chlorine content was as high as 428 ppm. In addition, it can be confirmed that not only the total chlorine content but also the content of each of organic chlorine and inorganic chlorine in Examples 1 to 4 was reduced more excellently than in Comparative Examples 1 to 4.

It can be confirmed that in Comparative Example 2, when pyrolysis was performed at 300° C., the pyrolysis process of waste plastic was not performed smoothly, and the yield was significantly reduced to 45%. Also, it can be confirmed that the total chlorine content in the pyrolysis oil was 500 ppm or more, and the chlorine removal rate was also degraded.

Although the embodiments of the present disclosure have been described above, they are not limited to the above embodiments and may be implemented in various forms different from each other, and those skilled in the art to which the present disclosure pertains will appreciate that various modifications and alterations may be made without changing the technical idea or essential features of the present disclosure.

1. A method for producing waste plastic pyrolysis oil with reduced chlorine, comprising:
a first step of preparing a feed containing 1 to 25 parts by weight of moisture based on 100 parts by weight of waste plastic; and
a second step of performing pyrolysis of the feed at 400 to 600° C.

2. The method of claim 1, wherein the moisture includes moisture contained in the waste plastic.

3. The method of claim 1, wherein the second step is performed in a non-oxidizing atmosphere.

4. The method of claim 3, wherein the non-oxidizing atmosphere is a water vapor atmosphere formed by pressurizing and purging a reactor with vaporized water vapor.

5. The method of claim 1, wherein the second step is performed under a normal pressure condition.

6. The method of claim 1, wherein the second step is performed in a batch reactor.

7. The method of claim 1, wherein a total chlorine content in the waste plastic pyrolysis oil produced through the first and second steps is 300 ppm or less.

8. The method of claim 1, wherein a total chlorine content in the pyrolysis oil produced through the first and second steps is removed by 80% or more compared to the feed.
